(19) United States
(12) Patent Application Publication
(10) Pub. No.: US 2011/0229860 A1
(43) Pub. Date: Sep. 22, 2011

(54) SYSTEM AND METHOD FOR INTERACTIVE ENTREPRENEURSHIP ACTIVITIES

(76) Inventors: Avshalom Leventhal, Ra'anana (IL); Ran Levy, Herzliya (IL)

(21) Appl. No.: 12/725,966

(22) Filed: Mar. 17, 2010

(51) Int. Cl. G09B 19/18; A63F 13/12

(52) U.S. Cl. 434/107; 463/42

(57) ABSTRACT

A system and a method for interactive entrepreneurial activities in a virtual environment through a computer network, such as the Internet for example.

### FIELD OF THE INVENTION

The present invention relates generally to the field of entrepreneurship interactive activities, and more specifically to such activities which involve performing virtual commercial activities in a virtual environment.

### BACKGROUND OF THE INVENTION

Many different methods to teach “entrepreneurship” and “entrepreneurial activities” have been sought, as such creativity is widely valued among companies and other employers. One non-limiting example of such a method is the business school “case study”, in which a professor brings an example case to his/her class, who must then attempt to solve the problem represented by the case. Of course, such a method requires intense pedagogical support and is not widely practicable through a computer network such as the Internet.

To attempt to fill this gap, various software solutions have been proposed. For example U.S. Pat. No. 7,349,838 teaches a management training simulation method and system. The taught method and system provides for decisions by individual students only and does not support team interactions. Also the taught method and system supports only static, simple business cases as described above, and is not flexible and dynamic. U.S. Pat. No. 6,236,955 teaches a similar method and system.

FARMVILLE provides a simple, static game, with limited capabilities and functions and without the ability to review a game playing profile of the players. The players of this game do not generally wish to own or work on a farm. Although not related to entrepreneurial activities, it is a typical example of a game provided through social networks which has enjoyed some success.

### SUMMARY OF THE INVENTION

Thus there is a need for, and it would be advantageous to have a system and method that supports entrepreneurial interactive activities in a virtual environment, for example in a social network through a computer network such as the Internet.

The present invention overcomes these deficiencies of the background art by providing (in some embodiments) a system and method for interactive entrepreneurial activities in a virtual environment through a computer network, such as the Internet for example. The game may optionally be customized; furthermore, the game is preferably dynamic, such that it responds to one or more actions of one or more game players in a dynamic manner, rather than only being a static game.

According to at least some embodiments of the present invention, the system and method are implemented through a social networking system that is accessible through a computer network, such as the Internet.

Social networking systems encompass certain on-line services that provide a group of individuals with the ability to collaborate with each other over the internet. Non-limiting examples of social networking systems may be found at “myspace.com”, “friendster.com”, “Facebook” (facebook.com) and “tribe.net”. Social networking systems generally consist of an on-line social network, which is represented by a map of the relationships between individuals. The social network, or map of relationships, indicates the ways in which such individuals are connected through various social familiarities ranging from casual acquaintance to close familial bonds. Also, marketing campaigns have started to use such social networking systems, both to propagate commercials but also to involve participants in such systems in the creation process of the marketing campaign itself. Two recent examples of brands that used social networking systems to create a marketing campaign are Mountain Dew® and Skittles®.

In at least some embodiments, the present invention also overcomes the drawbacks of the background art by providing a system and method for entrepreneurial activities of a team, optionally over the entire life cycle of a start-up company from founding to exit.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager. Any two or more of such devices in communication with each other, and/or any computer in communication with any other computer, may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows a schematic block diagram of an exemplary, illustrative system for entrepreneurial interactions according to the present invention;

FIG. 2 shows an exemplary, illustrative logic diagram of the game structure and flow according to at least some embodiments of the present invention;

FIG. 3 shows an exemplary, illustrative logic diagram of the game development flow according to at least some embodiments of the present invention;

FIG. 4A is an exemplary game creation process flowchart, while FIGS. 4B and 4C are exemplary game creation process screenshots;

FIG. 5 relates to the outcome of the game design process, with various exemplary structures and functions that may optionally be provided;

FIGS. 6A-6I shows some illustrative, exemplary screenshots for a player who is playing the game;

FIG. 7 shows human social network 700 and describes how the game according to at least some embodiments of the present invention may optionally be played through such a social network when implemented through a computer network as described herein;

FIG. 8 shows an exemplary, illustrative non-limiting flowchart for a method for implementing a game within a social network; and

FIGS. 9-1 to 9-4 relate to exemplary, non-limiting lists of parameters for evaluating performance for a game designer or manager to use for viewing the values for one or more parameters for the participant profile agent (FIG. 9-1); the management skills agent (FIG. 9-2); the market demand agent (FIG. 9-3); and the venture progress/status agent (FIG. 9-4).

### DESCRIPTION OF THE PREFERRED EMBODIMENTS

The present invention is of a system and method for interactive entrepreneurial activities in a virtual environment through a computer network, such as the Internet for example.

According to some embodiments of the present invention, the interactive entrepreneurial activities may optionally be implemented as a game, whether for a closed group (for example for an organization, company or other invitation only group) or for an open group. A non-limiting example of an open group could optionally be participants who voluntarily join the game from a social network or other Internet based group.

According to other embodiments of the present invention, the interactive entrepreneurial activities could optionally be implemented as a “test laboratory” for testing a new concept, slogan, marketing campaign and so forth. Such a test laboratory could optionally be used by an individual or group wishing to start a new company, or an existing company or organization. In this context, the game may optionally replace the business “case study” as implemented in universities and other academic institutions for the purpose of teaching some aspect of business administration or management. For these embodiments, again the game may optionally be implemented for a closed group (for example for an organization, company or other invitation only group) or for an open group. A non-limiting example of an open group could again optionally be participants who voluntarily join the game from a social network or other Internet based group. Preferably the choice of open or closed group is made by the sponsor of the test laboratory.

For implementation of the game as a test laboratory, preferably the sponsor of the game (ie the sponsor of the test laboratory) is able to set one or more goals or objectives for the game, according to which the game is implemented as described in greater detail below.

For any of the above embodiments of the present invention, optionally the game may be customized, for example by a game designer and/or sponsor. Such customization is preferably supported by software, described in greater detail below, which easily enables the individual constructing the game to select from various menu choices, add content and otherwise develop the game.

According to other embodiments of the present invention, the supporting software and/or system is implemented through a social network, as described above and also as described in greater detail below. Implementations of various types of applications through social networks are known in the art, for example as “apps”. However the implementation of interactive entrepreneurial activities is not known in the art; nonetheless, from the description provided herein could easily adapt the described implementation(s) for operation through any type of social network.

According to still other embodiments of the present invention, the supporting software and/or system further comprises a language for constructing the game and for game design. The language preferably includes a plurality of independent objects which interact with each other, optionally in place of, or in addition to, a rules based engine. Each object is governed by one or more rules which governs its interactions with one or more other objects. The objects also preferably relate to the typical business vocabulary, such as for example valuation, dilution, negotiation, term sheet and so forth. Optionally specialized vocabulary may be added by a game designer.

Optionally, the language comprises a plurality of keywords, each keyword being related to rule in a rule base for interpretation by the game engine.

According to yet other embodiments of the present invention, the profile of a game player, as well as one or more actions taken by that player, determines how the game interacts with that game player, for example in terms of selecting an event to occur for that player and/or frequency of events. As a non-limiting example, if an inexperienced game player fails to participate for a given period of time, that game player could optionally receive a different event than an experienced game player who also failed to participate for a period of time. Also actions, or lack of actions, by a game player may also determine which event that game player receives, also as described in greater detail below.

For the purpose of explanation only and without any intention of being limiting, the below embodiments are described with regard to implementation of the system and method in the form of an interactive game.

The principles and operation of the present invention may be better understood with reference to the drawings and the accompanying description.

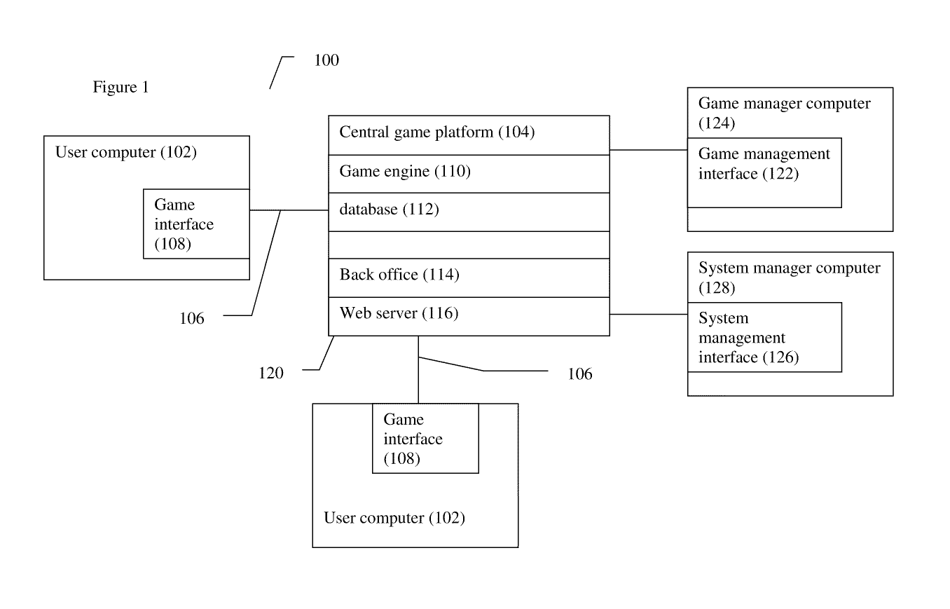

Referring now to the drawings, FIG. 1 shows a schematic block diagram of an exemplary, illustrative system for entrepreneurial interactions according to the present invention. As shown, a system 100 features a plurality of user computers 102 for interacting with users, of which two are shown for the purpose of explanation only and without being limiting in any way. User computers 102 communicate with a central game platform 104 through a computer network 106, such as the Internet for example. For playing the game by performing the interactive entrepreneurial activities, each user computer 102 preferably operates a game interface 108, which may optionally be implemented as stand-alone software, as a plug-in to a web browser, or through a web based interface of another type, such as a social network for example (as described in greater detail below).

Central game platform 104 preferably features a game engine 110 for providing events to the players through game interfaces 108, for reacting to actions by the players and for maintaining the game in a “stateful” manner. By “stateful” it is meant that game engine 110 maintains the state of play, in terms of the status of the players, any commercial activities being performed by the players, any other virtual activities and so forth.

Non-limiting examples of events include social events. For example, if another game player or social networking system participant wishes to join a start-up, a founder game player might optionally receive the following message: “Ron Smith has offered to join your venture as a co-founder, to learn more click here”. As another example, a founder game player, in the role of “CEO” for example, could optionally invite another game player and/or social networking system participant for employment in his/her start-up, for example with the following message: David Drocker, the CEO of “SmokingRange” would like to offer you a position in his venture, to learn more click here. A game player and/or social networking system participant could, conversely, request a position at a start-up: for example, a message could optionally be sent stating: Dan Black would be interested in becoming a director in your venture, to learn more click here.

Another non-limiting category of events are human resource related events. Such events may optionally occur for both virtual and human (ie game player) employees. Two non-limiting examples of messages announcing such events are as follows: “Shirley Gold, an employee in your venture gave a month's notice, and will be leaving her position as senior engineer in the venture, to learn more click here”; or “Omer Night, your VP for engineering, is sick and will not come to work for the next two weeks, to learn more click here”.

Another non-limiting category of events are investment related events, for example regarding whether an investor is interested in providing funds, has provided funds or has a rejected a request for funds, and/or events related to the current financial status of the company. For example, a message related to investor interest could optionally state “BlackBridge Funds, a venture capital firm is interested to learn more about your venture, to learn more click here”. Conversely if a firm has decided not to invest funds, the message could optionally state “The Funds, a venture capital firm has rejected your request for fund support, to learn more click here”. A message relating to the financial status of the company could optionally state “Due to the negative cash flow of the venture, the investor are asking to set up an urgent board meeting, to learn more click here”.

Another non-limiting category of events are production related events, for example with regard to the status, operations and/or cost of equipment, raw materials and so forth. Two non-limiting examples of messages are “The machine of your first line of production is broken, you need to spend $5,000 to fix it, to learn more click here”; and “The cost of the raw material will increase by 3% starting next month, to learn more click here”.

Events may also optionally be characterized as on-going events (as opposed to a single occurrence), for example optionally including but not limited to board meetings, shareholder meetings and management meetings (which would typically occur periodically and repeatedly); and prolonged events such as due diligence processes, closing processes and so forth.

Game engine 110 preferably provides information regarding the game set-up, any rules or restrictions on gameplay, as well as templates for game situations, characters in the game (particularly virtual characters), flow processes and so forth, all of which are preferably stored in a database 112. For example, database 112 preferably contains information on a commercial problem to be solved or other goal of the game, as well as a description of virtual characters, including but not limited to virtual participants, virtual investors, virtual employees, virtual resellers, virtual sub-contractors and so forth. Game engine 110 preferably provides reactions of such virtual characters to one or more actions or interactions of the game player or to one or more actions of another virtual participant, and/or according to one or more events generated by a back office 114.

Back office 114 preferably supports translation, transformation, formatting and so forth of the output of game engine 110. Back office 114 also preferably handles interactions of game interfaces 108 in terms of receiving input, actions and so forth from game interfaces 108. Back office 114 also preferably manages virtual characters in the game, also as described in greater detail below.

During game play, each player (user) interacts with game interface 108 as operated by user computer 102. The game process preferably involves a complete virtual commercial activity, whether starting a virtual company, launching a virtual product, bringing a virtual company or product from one status to another and so forth. At the start, each player receives an initial description of the game through game interface 108, preferably including a description of the commercial activity to be performed, availability of virtual characters or resources and/or availability of other real players or resources. Such real players or resources are not necessarily available. If available, a real player is another user who interacts with game interface 108 through user computer 102. Such real players may optionally fulfill a variety of tasks, including but not limited to founders of companies, employees of companies, investors in companies, board members/directors, and consumers of products or marketing by the company. Thus, each virtual commercial activity, and hence each game, may optionally be performed or played by a team of users through their respective user computers 102.

Each player then interacts with game interface 108. If more than one player is on a team, then the players also interact with each other through game interface 108. Each player enters one or more actions or reactions through game interface 108, which are then provided to central game platform 104. Central game platform 104, through the interactions of game engine 110 and back office 114, then provides information, events or reactions back to players through game interfaces 108. The game process continues, optionally with one or more manual interventions but preferably automatically, until a state of play is reach at which either a winner is declared or further game play is no longer possible. Central game platform 104 then optionally and preferably provides feedback on each player's performance or a team's performance through game interface 108.

Central game platform 104 optionally also provides a web server 116 for supporting interactions with game interfaces 108. Web server 116 for example may optionally interact with game interface 108 if implemented as a plug-in to a web browser; web server 116 may also optionally interact with game interface 108 by providing mark-up language documents and so forth. As noted above, web server 116 is optionally not present, for example if game interface 108 is implemented through a web based interface of another type, such as a social network for example (as described in greater detail below).

Central game platform 104 is preferably operated by a computer 120, such as a server, although it may optionally be operated by a plurality of computers through distributed computing.

According to at least some embodiments of the present invention, system 100 also optionally includes a game manager interface 122, operated by a game manager computer 124, for a game manager who may act for example as a game administrator as described in greater detail below. System 100 may also optionally include a system manager interface 126, operated by a system manager computer 128, for a system manager who may act for example as a system administrator as described in greater detail below.

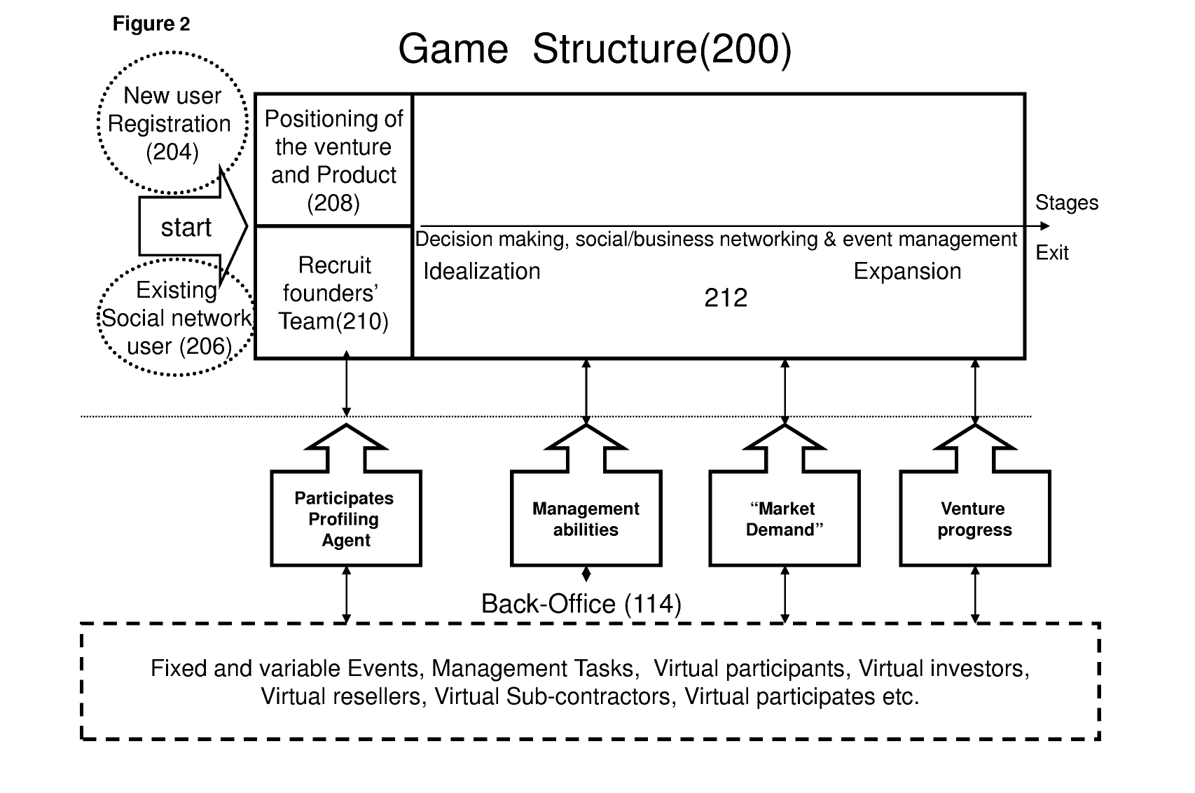

FIG. 2 shows an exemplary, illustrative logic diagram of the game structure and flow according to at least some embodiments of the present invention. For this non-limiting example, the game is provided for launching and developing a start-up company around a predetermined product, although of course other types of games may also optionally be performed.

A game structure 200 preferably features a start 202, either through new user registration 204 or through a process 206 that enables an existing social network user to join. After start 202, the game process preferably proceeds through a plurality of stages. A first stage 208 preferably involves positioning of the start-up company and the product. For example, the player preferably needs to determine such factors as the name of the company and of the product, a slogan and logo for the company/product, a web site and so forth.

In a second stage 210, which may optionally be performed simultaneously with or sequentially to stage 208, the player optionally and preferably recruits a team of founders, which more preferably are other “real” players as described with regard to FIG. 1. Therefore after this stage, preferably a team of real players interact together to act as the founders of the virtual start-up company.

In a plurality of following stages 212 the game process continues, preferably including decision making, social/business networking and event management, as the team of players interacts with the game, more preferably until an exit stage 214. More details regarding examples of game play are provided below.

To support the above stages, the game process is preferably supported by back office 114 (described in greater detail with regard to FIG. 1). Back office 114 preferably provides, to the game players, the various functions of the games, preferably including but not limited to fixed and variable events, management tasks, and also various virtual characters, including for example virtual participants, virtual investors, virtual employees, virtual resellers, virtual sub-contractors and so forth.

Specific game functions supported by back office 114 preferably include but are not limited to a participant profiling agent 216, a management abilities analyzer 218, a market demand module 220 and a venture progress analyzer 222. Participant profiling agent 216 preferably provides profiles of one or more “real” players, for example as employees. Preferably, for all employees, including the founders, participant profiling agent 216 indicates the desired salary, capabilities and so forth, for the purpose of negotiation, preferably before game play starts.

Management abilities analyzer 218 preferably analyzes the activities during actual game play of the team of founders who are all game players and hence are “real” players. Management abilities analyzer 218 receives a broad list of parameters for analyzing such activities; it then determines whether any such activities meet or match any of the parameters. Optionally management abilities analyzer 218 may determine the extent to which a parameter is matched. For example, if a parameter relates to participation by a game player, management abilities analyzer 218 may optionally determine frequency of such participation, time of participation, time required for a game player to react to a particular event and so forth.

Input from participant profiling agent 216 and/or management abilities analyzer 218 to back office 114 (and hence to game engine 110 of FIG. 1) may also optionally determine the type, characteristics and frequency of events that are provided to the game players, as described in greater detail above.

Market demand module 220 preferably provides the virtual reaction of a virtual market to the commercial activities of the start-up company. For example, if the game is implemented through a social network as described in greater detail below, then the virtual market may optionally comprise participants in the social network. In this example, the commercial activities may optionally include setting up a web page; the parameter(s) measured may therefore optionally relate to the reaction of social network participants to the webpage, providing and operating a loyalty program or “club” (for example, how many people enter to see the webpage, how they react, whether feedback is positive or negative, the number of repeat viewers, how many social network participants join the loyalty club, customer satisfaction rates and so forth).

Venture progress analyzer 222 preferably analyzes the actions of the players, and also the effects of various provided events from back office 114, to determine the progress of the game players within the game, for example the progress of the start-up company. Venture progress analyzer 222 preferably measures such progress against a plurality of benchmarks and standards for determining whether progress has been made, for example according to whether the start-up company has fulfilled one or more specific goals within a particular period of time; for example, to raise money from a virtual investor or a “real” investor (ie a game player who has either been given funds or who has put up his/her own funds for potential investment) within a particular period of time.

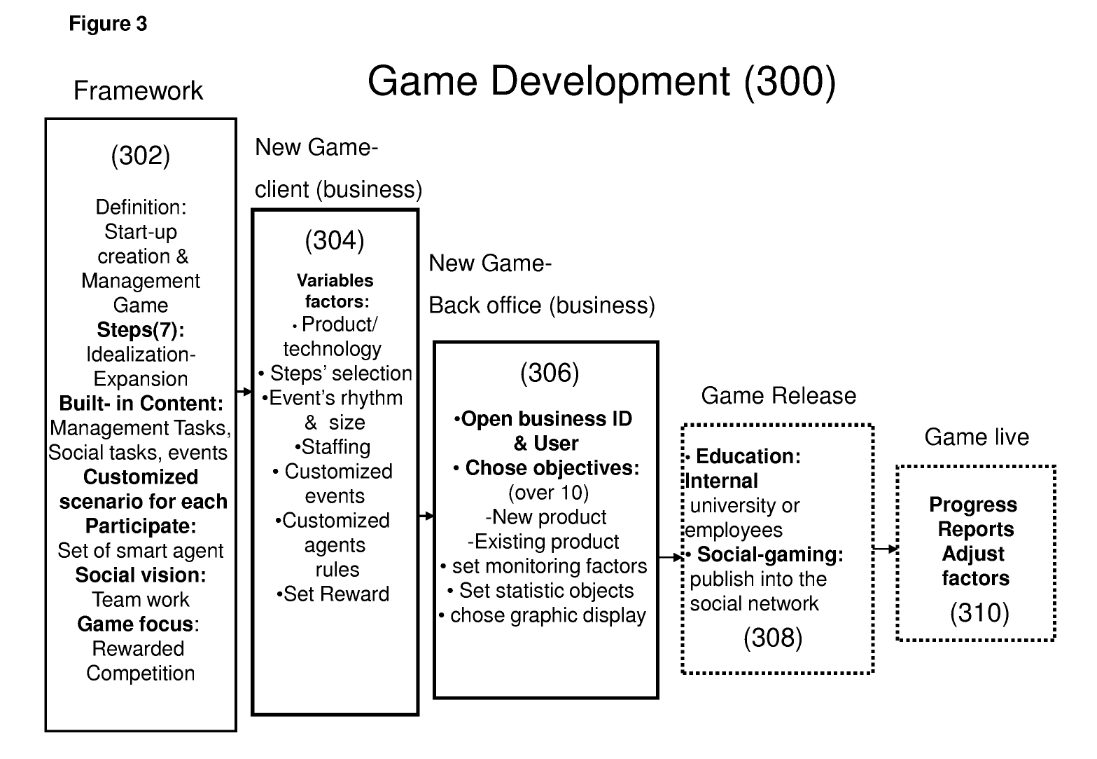

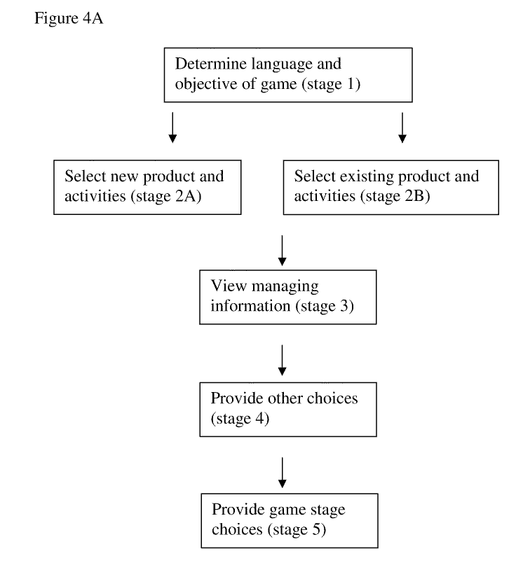

FIG. 3 shows an exemplary, illustrative logic diagram of the game development flow according to at least some embodiments of the present invention. A game development flow 300 preferably starts with construction of a framework 302 for the game. Framework 302 preferably features a definition of the game, for example as a start-up creation and management game, which is determined by the game designer. Framework 302 also preferably includes a definition of the stages involved in the game, from idealization to expansion. For example, optionally seven such stages may be defined. A new framework 302 is preferably constructed for each game. Optionally, if the game is being designed by a company or organization, that company or organization may be required to pay a fee for designing and implementing the game. Payment may also be made, additionally or alternatively, through advertisements, sales of virtual goods and so forth, as implemented in the context of the game and of framework 302.

The game designer also preferably determines built-in content for framework 302, for example optionally including the following: Management Tasks (which may optionally include such milestones as fundraising, creation of a prototype and so forth), Social tasks (which may optionally relate to development of a virtual market and so forth), events and so forth. Customized scenarios for each participant are preferably also provided through framework 302, for example as a set of smart agents, as described in greater detail below.

A social vision, for example relating to team work or other interactions of the real human participants (players), is preferably also provided for framework 302. Optionally, framework 302 indicates whether only virtual employees are allowed or whether real game players may also optionally be permitted as employees. Framework 302 also preferably provides the game focus, for example with regard to rewards and competition.

Next, a new game client 304 is preferably designed, in terms of the interactions of the players with the central platform. New game client 304 preferably includes various variables or factors which determine the type and style of such interactions with the player, and also optionally includes definitions for particular customized events, rules and agents, as well as setting rewards. For example, for governing the type and style of such interactions, new game client 304 optionally includes definitions of the product and technology; detailing the specific stages in the game, although optionally an outline of such stages was previously determined; determining the rhythm and size of the events; staffing (optionally including virtual employees) and so forth.

A new game back office 306 is then preferably designed, to support the interactions as determined with regard to framework 302 and new game client 304. New game back office 306 preferably includes opening a business record or identifier, and user selection. In addition, the objectives of the game are selected and are provided to the new game back office 306, of which preferably at least 10 such objectives are provided. In addition, preferably the overall focus of the game is considered, for example whether it relates to a new or existing product, and/or whether it relates to a new or existing company and so forth. Monitoring factors are preferably selected, for example to determine whether the human players are performing effectively or according to certain standards or expectations. The type and frequency of monitoring are also preferably selected.

Statistical objectives are selected according to the goal(s) of the game. For example if the goal of the game is create a slogan, then the statistical objective could optionally be determining the most popular slogan for example. Other examples of statistical analysis include but are not limited to determining popularity of the game, recent performance, participation levels and so forth. A graphic display is also preferably selected; for example, such a display may optionally have a particular look and feel, or else may be branded for a particular company or organization, and so forth.

Some non-limiting examples of goals or objects of the game comprise such a goal related to a specific product and/or to a start-up company. If the game relates to a product (whether as a stand-alone or as part of a start-up company), then the competitors in the game, who are game players, preferably only compete with regard to such a specific product.

If the goal of the game relates to a start-up company, the method preferably also includes providing feedback relating to an action of a game player and/or to a reaction of a participant in a social networking system (if in fact the game is implemented through a social networking system).

Next, the game release 308 is structured, according to the “wrapper” or type of execution required for the game. For example, if a game is intended for education for a particular company or organization, such as a university for example, then the game is preferably designed for internal release. In this case, the “wrapper” could optionally feature security measures, a requirement for limited execution or availability, being placed on a particular server and so forth. However, the game could also optionally be available to the public, in which case the wrapper preferably enables the game to be accessed through a public interface, such as a social network for example.

Next the game is actually released in a “game live 310” stage. Preferably as game play occurs, progress reports and feedback are provided, which may optionally allow one or more factors to be adjusted.

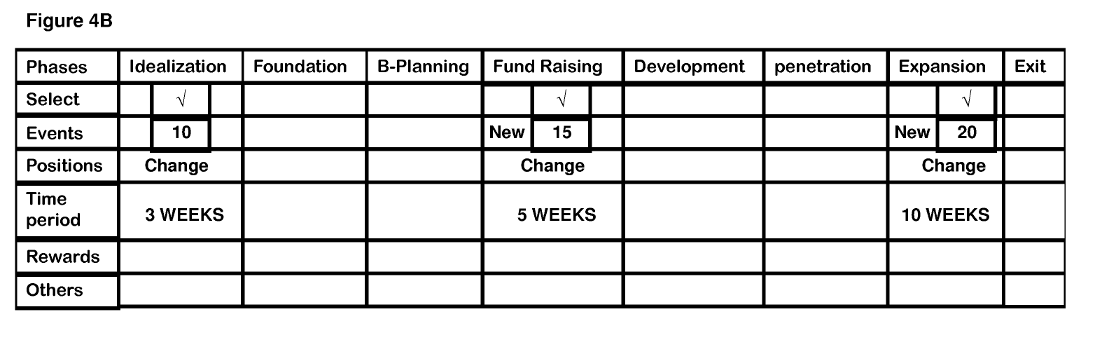

These stages are shown with regard to the exemplary game creation process flowchart in FIG. 4A and screenshots in FIGS. 4B and 4C. These flowchart and screenshots provide an illustrative, non-limiting example for interactions of a game designer with game creation software according to at least some embodiments of the present invention, in which a non-programmer is preferably able to make choices and add details and rules to create the game.

As shown, in FIG. 4A, in stage 1, the game designer is first asked to determine the language and overall objective of the game. For the latter, two choices are shown in the non-limiting example: new product or existing product.

Next, as shown in stage 2A, the game designer (who is assumed to have selected a “new product” for the purpose of this non-limiting example) now is asked to indicate which activities are to be performed for this new product. The choices shown include determining a brand name, a slogan, creating a marketing “buzz” or campaign before the product's release, designing and performing customer/product surveys, or determining the profile for a potential customer, or a combination thereof. Multiple choices are permitted, although it is also possible to make only one choice (for example, for an organization which wishes to educate players in the selection of a brand name or designing a pre-release campaign). The game designer can then choose to save these choices.

Alternatively, as shown with regard to stage 2B, if the game designer instead had selected “existing product”, then a different set of choices is provided. As shown, the non-limiting, exemplary, illustrative set of choices for the game objective optionally includes determining one or more of public relations, repositioning an existing product (for example in a new market), creating a loyalty program, creating an advertisement or advertising campaign, or measuring customer satisfaction.

In stage 3, the game designer is able to view the game designer's account, including such information as managing information about the product, such as for example the definition of the product, a list of requirements and so forth; being able to add or manage photographs to the game; enabling credit cards to be used for gifts or other virtual goods (the credit cards may also optionally be virtual credit cards, such that the game designer may optionally decide to provide game credit for such virtual goods).

In stage 4, optionally other choices are provided to the game designer, for example including general settings (for example whether to suggest part of the game GUI, such as a page, and determining whether the game designer is the admin for the page); management of events, including establishing, canceling or inviting the game designer to the event, determining whether the game designer is the event admin and so forth; and also managing notes, for example to assist the administrator of the game.

In stage 5, the choices of various game stages are optionally and preferably provided to the game designer, which the game designer may optionally select. The non-limiting examples of the choices include idealization, foundation, business plan development (b-planning), fund raising, development, penetration, expansion and exit. The game designer may optionally select one or more stages; in this example, the game designer has selected idealization, fund raising and expansion. The game designer may also optionally select the permitted time period for each stage in terms of the number of weeks permitted. The game designer may also optionally select the number of events that are to occur at each stage, as well as any rewards to be provided for successful completion of each stage.

FIGS. 4B and 4C show exemplary, illustrative non-limiting screenshots related to the optional but preferred choices for game design as described with regard to stage 5 above.

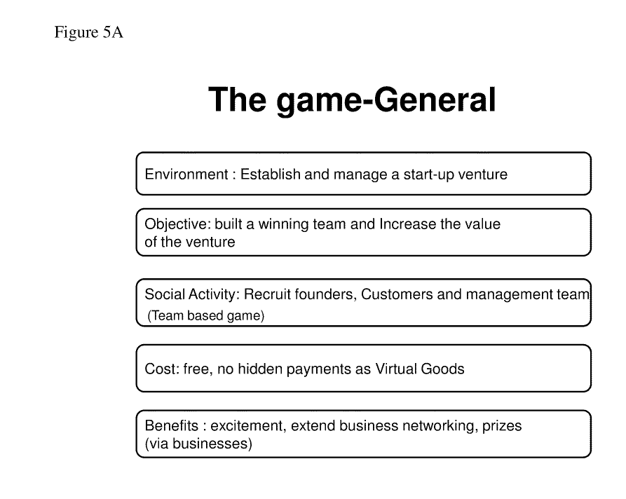

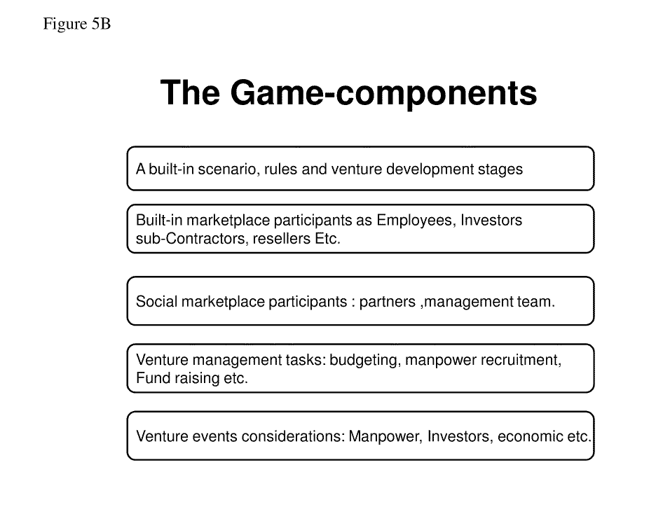

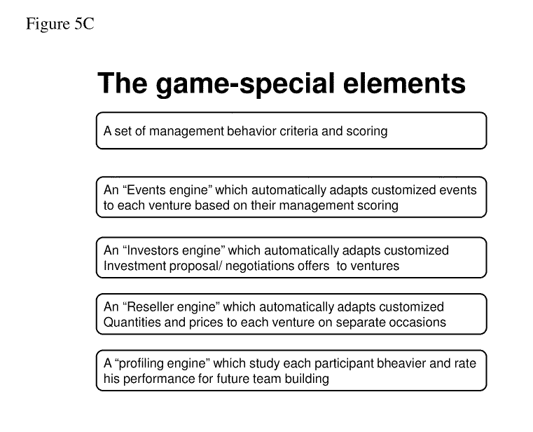

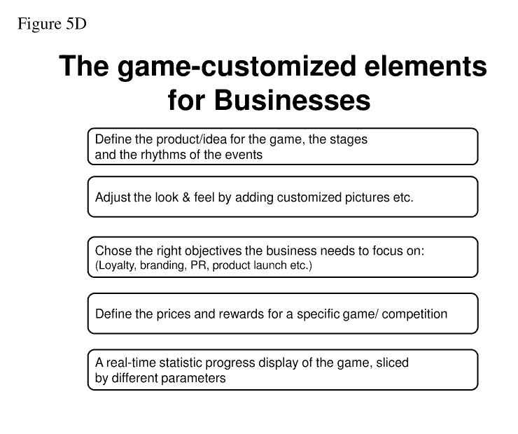

FIG. 5 relates to the outcome of the game design process, with various exemplary structures and functions that may optionally be provided. FIG. 5A shows an exemplary, illustrative general game structure, with the general environment: Establish and manage a start-up venture; Objective: build a winning team and increase the value of the venture; for a team based game, the social activity may be defined as Recruit founders, Customers and management team; the determination of the cost (in this example, free); benefits or rewards, such as excitement, extend business networking, prizes (via businesses) and so forth.

FIG. 5B shows an exemplary game structure with game components, for example with built-in scenario, rules and venture development stages; built-in “marketplace participants” as Employees, Investors, sub-Contractors, resellers; “social marketplace” participants: partners, management team; venture management tasks: budgeting, manpower recruitment, fund raising etc; or venture event considerations: Manpower, Investors, economic etc.

FIG. 5C shows some exemplary special features of the game which may optionally be selected or determined by the game designer, for example a set of management behavior criteria and scoring; an “Events engine” which automatically adapts customized events to each venture based on their management scoring; an “Investors engine” which automatically adapts customized Investment proposal/negotiations offers to ventures; a “Reseller engine” which automatically adapts customized quantities and prices to each venture on separate occasions; a “profiling engine” which studies each participant and rates his/her performance for future team building.

FIG. 5D shows some exemplary, illustrative “special” options which may optionally be made available to a particular organization or business. For example, the organization or business may optionally choose to define the product/idea for the game, the stages and/or the rhythms of the events; adjust the look and feel by adding customized pictures etc.; choose the right objectives for the game (or virtual business), for example to focus on loyalty, branding, public relations/marketing, product launch etc.; defining the prices and rewards for a specific game/competition; and/or a real-time statistic progress display of the game, sliced by different parameters, for example as previously described.

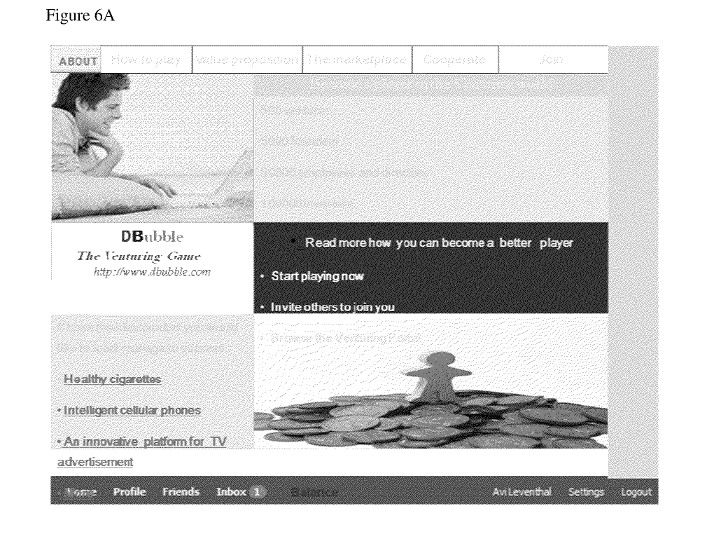

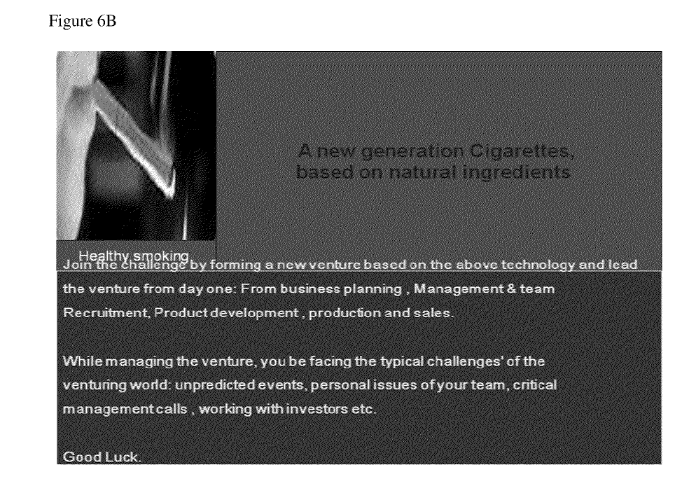

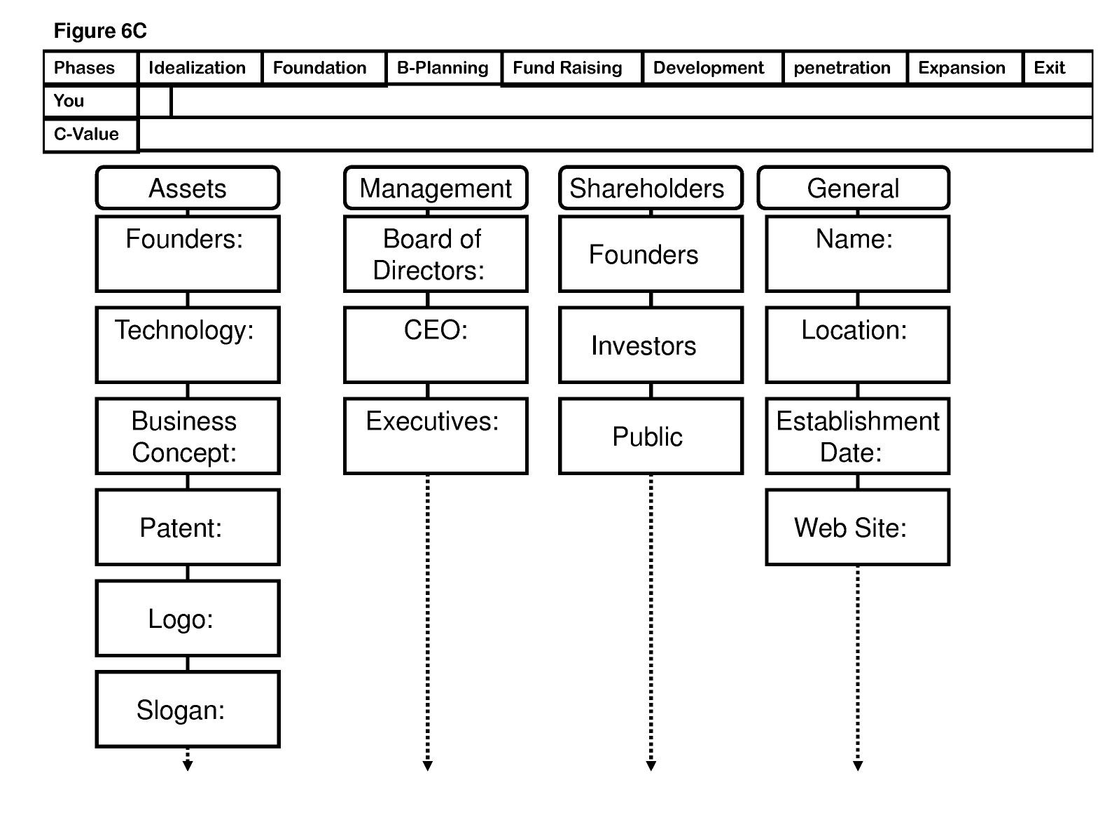

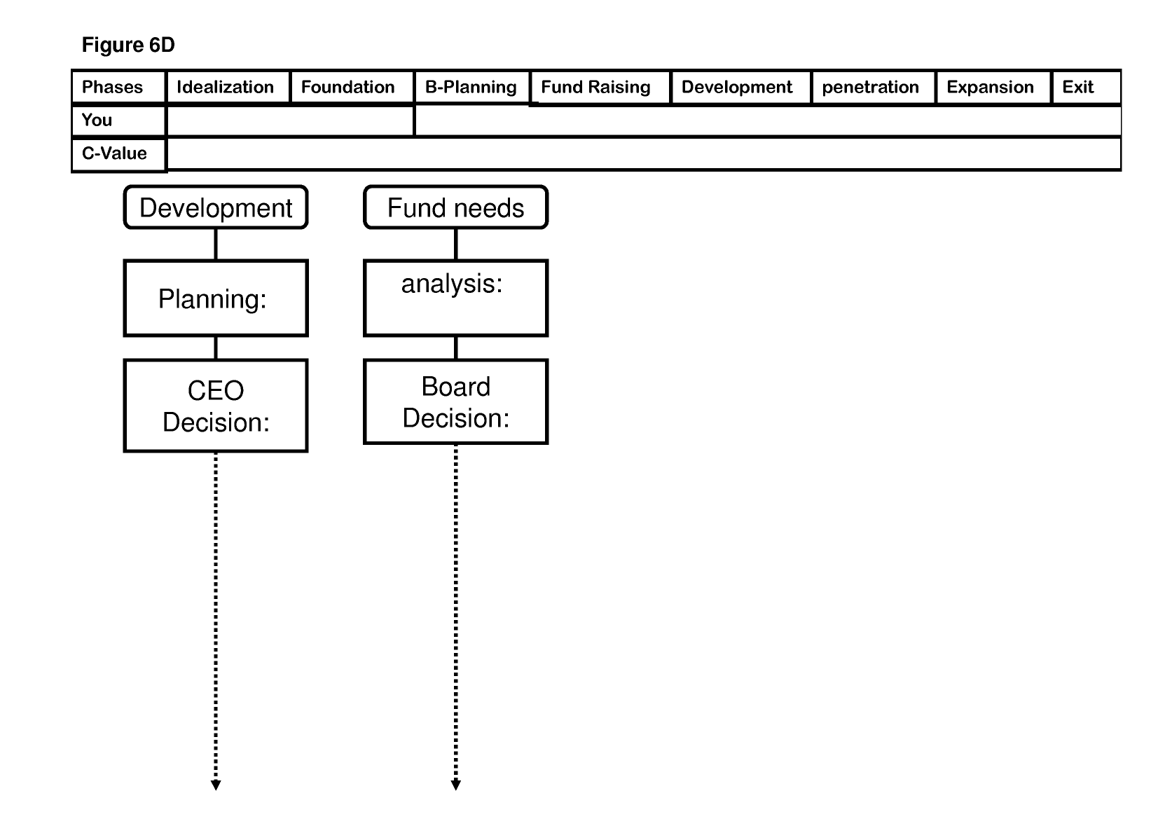

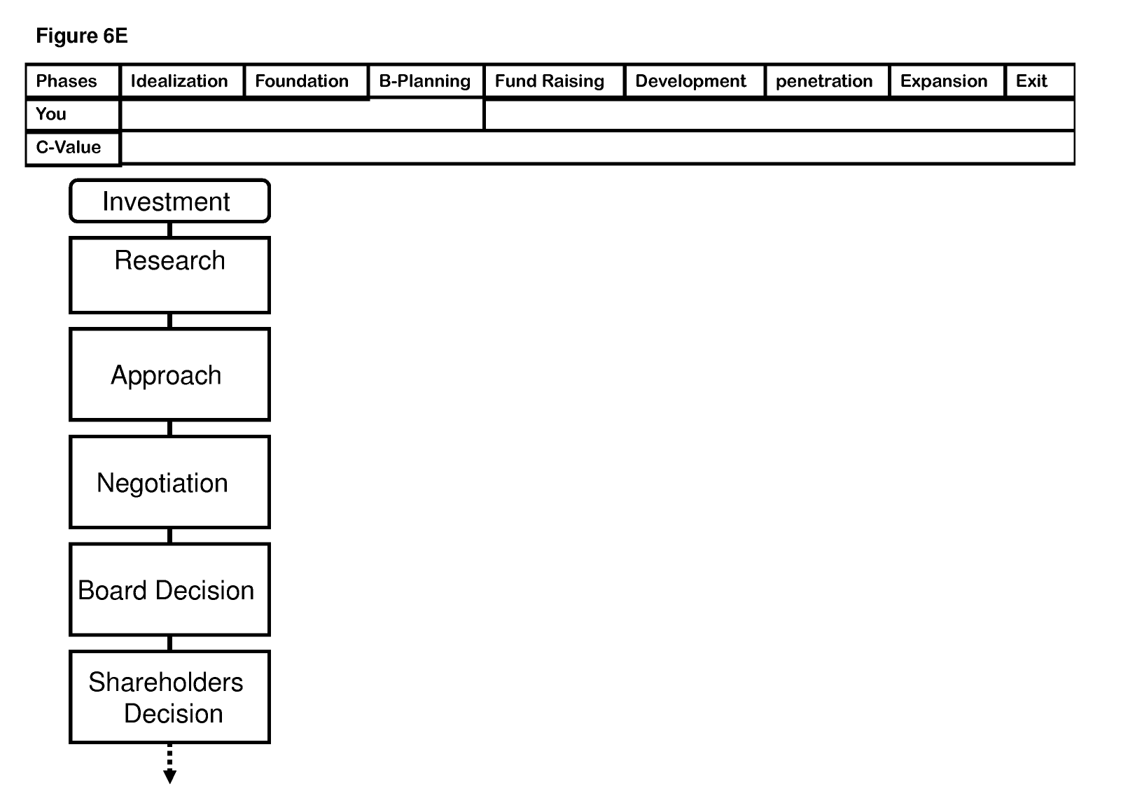

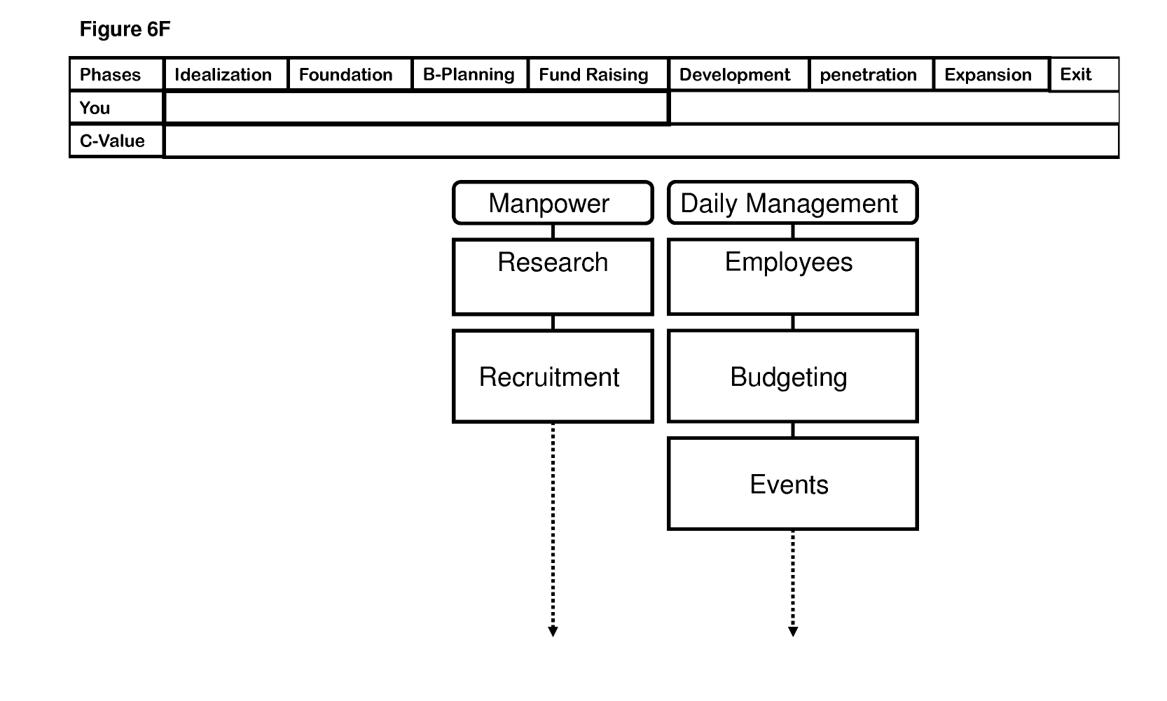

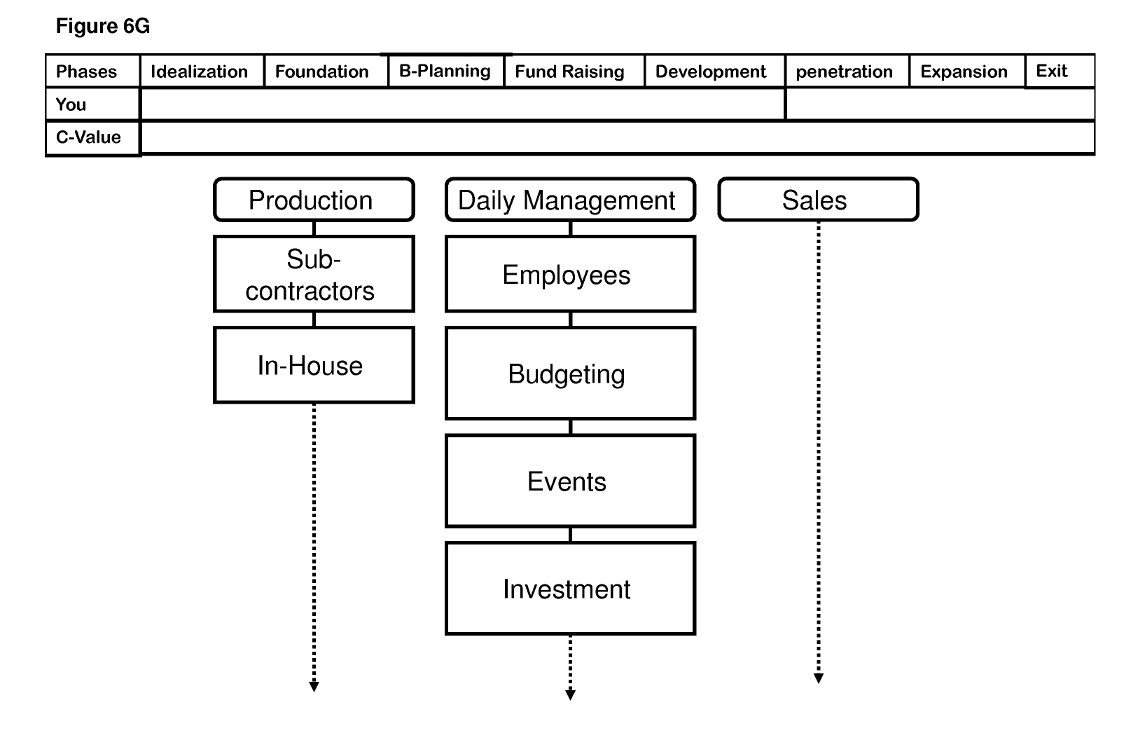

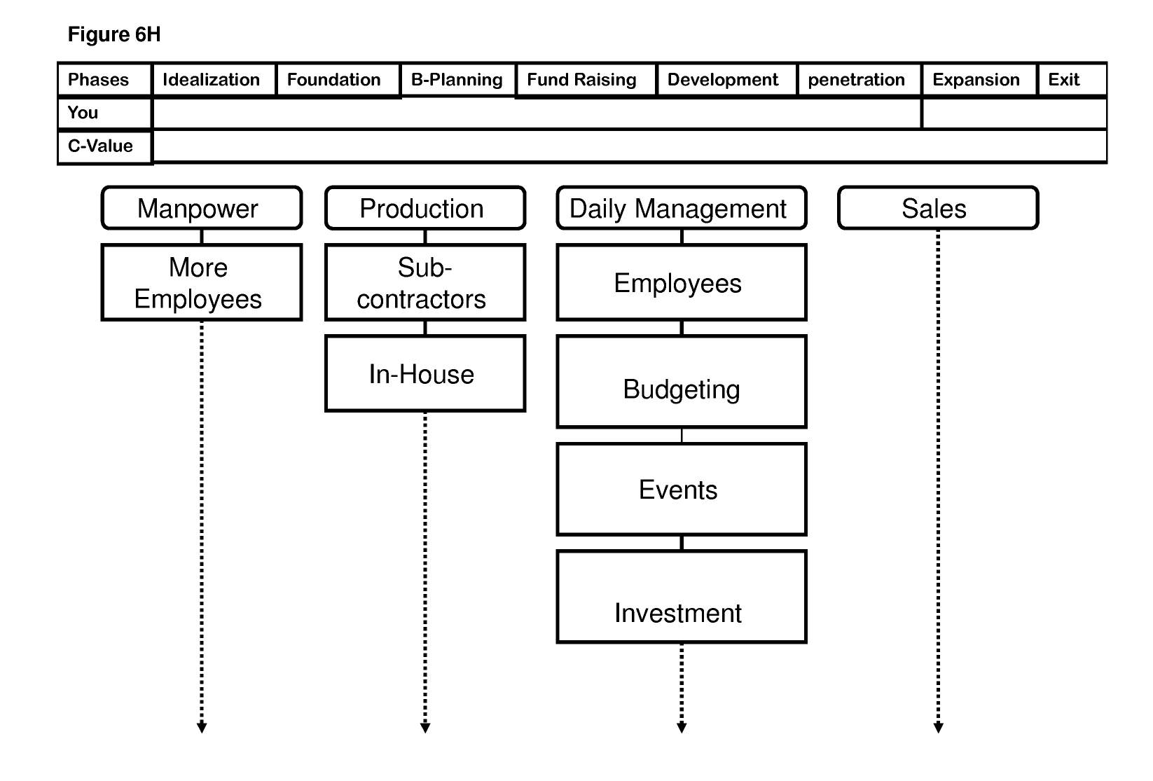

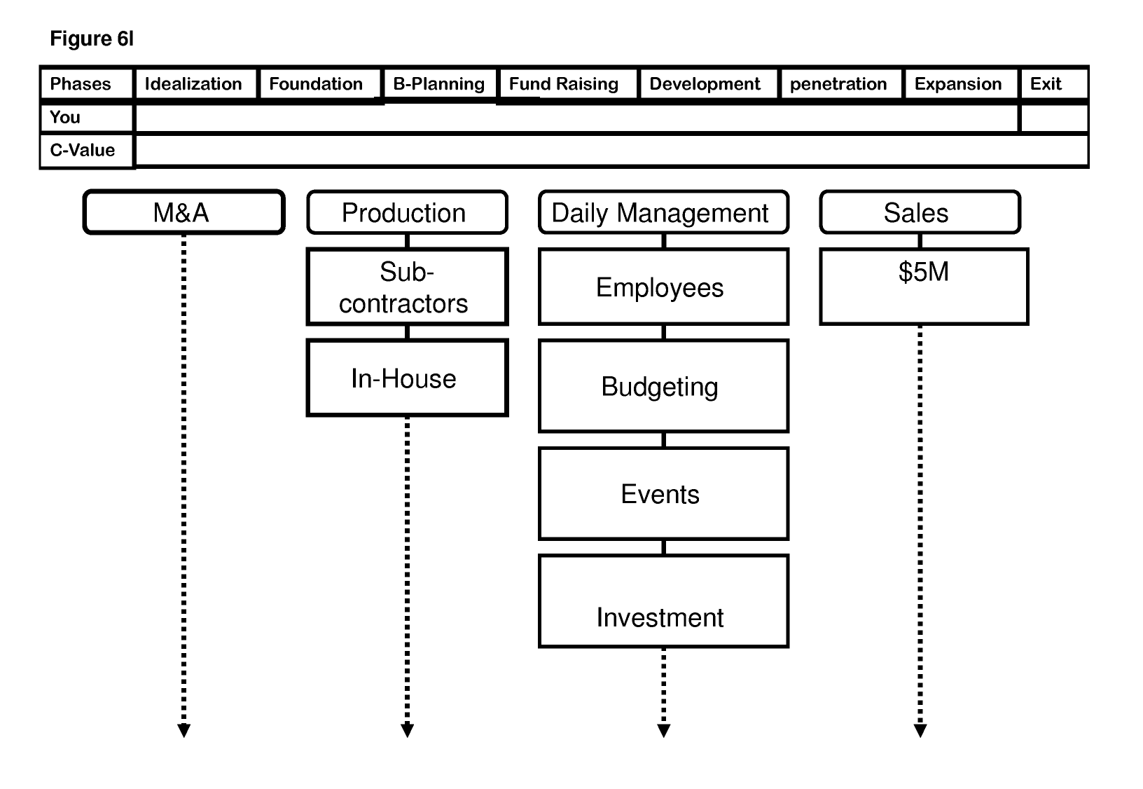

FIG. 6 shows some illustrative, exemplary screenshots for a player who is playing the game. As shown with regard to FIG. 6A, the game player first enters the game through an illustrative portal or entry display. The display includes a list of potential new products around which a start-up company may be started and developed during the game. FIG. 6B shows that the player has selected a new product, the “healthy cigarette”; a brief description of this new product is provided.

FIG. 6C starts the process of playing the game, with the first stage of idealization.

In FIG. 6D, the game process has passed to the foundation stage, which in this example includes planning of development and also determining fund raising needs. In FIG. 6E, the fund raising stage is performed, which in this example mainly relates to investment (locating investors, receiving funds and so forth). In FIG. 6F, the development stage is performed, which involves hiring employees (including virtual employees), managing a budget, reacting to events and so forth.

FIG. 6G shows the stage of penetration, including production, daily management, and planning for sales. FIG. 6H relates to expansion of the company into the market and FIG. 6I relates to another view of expansion of the company into the market. Although not shown, optionally there is a stage which may occur at any time, relating to failure or liquidation of the venture, such as of the start-up for example. Such a stage may optionally be forced upon the game players if one or more criteria are met, such as for example failure to raise money or the state of insufficient funds.

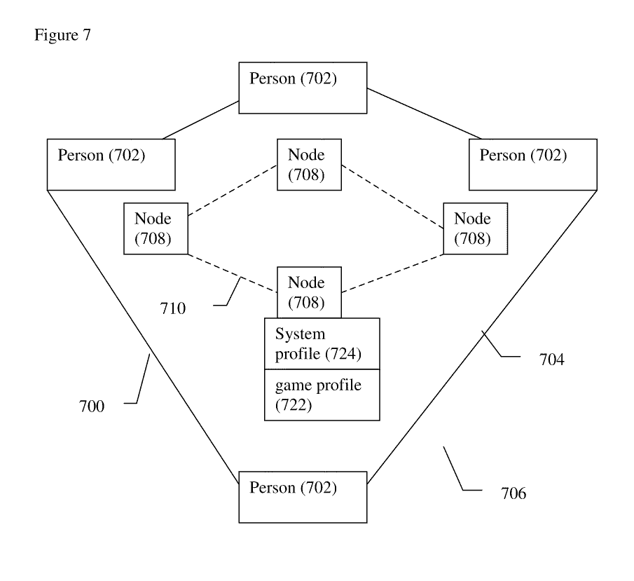

FIG. 7 shows human social network 700 and describes how the game according to at least some embodiments of the present invention may optionally be played through such a social network when implemented through a computer network as described herein. The human social network 700 is a network of persons 702 linked by some social relationships 704. The persons 702 and relationships 704 can be of any type. For example, the persons 702 may be employees of a company and the relationships 704 might be “know” relationships (who knows who), who has communicated with who, etc. The human social network 700 can be represented by information stored on a computer, preferably as a graph. In FIG. 7, social network 706 represents the human social network 700. The social network 706 has nodes 708 that correspond to respective persons 702, and connectors 710 that correspond to the relationships 704.

As described herein, preferably the human social network 700 relates to a computer network, wherein communication between nodes 708 occurs through computers operated by respective persons 702. Optionally, each such node 708 represents an on-line presence of a person 702, for example through a computer of any time, whether a personal computer, hand held device, a smart telephone or any type of cellular telephone, pager or other wireless communication device. Therefore, social network 706 is preferably implemented as a computer network.

The information that makes up the social network 706 can be obtained in many ways and from many types of sources. For example, a person can manually add a node representing his or her self and a set of people to which the person is related. Information about how they are related can also be added. Detail about the person can be included with the node. Information for the social network 706 can also be collected automatically from communication information such as sent email messages (sender and receiver fields can be used to build connections), documents such as news articles (semantic analysis of documents can reveal relationships between people), web pages or structured documents (people and their relations may be indicated by tags), a database storing records about people and perhaps transactions between them, and so on. A social network can also be built up from other social networks.

FIG. 7 shows that social network 706 preferably also comprises a game profile 722 for at least one person 702, which preferably represents on-line information that is stored and accessed through a computer network as related to the game playing activities of that person 702. Game profile 722 is preferably associated with yet is separate from a social network system profile 124 for the user 702 at node 708, but may optionally also form a part of the social network system profile 724 itself. It is understood that social network 706 is operated through a computer system, with a plurality of computers, for example optionally such that each node 708 comprises a user computer (or at least a computer accessible by the user 702). For the purpose of description only and without any intention of being limited, it should be noted that such a user computer could optionally comprise a wireless device, such as a cellular telephone for example.

The game players preferably play the game through social network 706, which in turn preferably interacts with the central platform (not shown, see FIG. 1) to receive events, information, reactions and so forth and to provide game playing activities of the users 702 to the central platform.

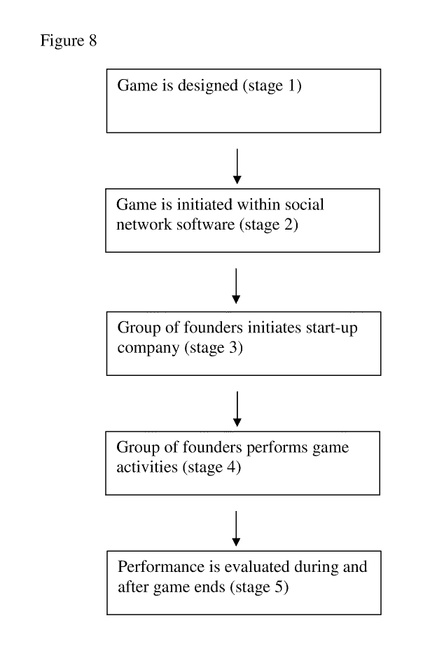

FIG. 8 shows an exemplary, illustrative non-limiting flowchart for a method for implementing a game within a social network, as for example the social network of FIG. 7. As shown, in stage 1, a game is designed as described above. For this non-limiting example, the game is assumed to be for starting, developing and operating a start-up company through to some final objective, which for this non-limiting example is assumed to be an exit (ie sale of the company, floating the company on a stock exchange or some other significant alteration to the capital structure of the company). The final objectives, milestones, evaluation parameters and so forth are preferably set in this stage, along with the game framework as previously described. Optionally and preferably, one or more general parameters of the product to be developed during the game are also set during this stage.

In stage 2, the game is initiated within the context of a social network software system, for example as shown with regard to FIG. 7 above. For example, if the game is to be open to all participants in the social network, then preferably an invitation is sent to the participants or at least the game is made available to the participants.

In stage 3, a group of founders (game players) from the social network decides to found a start-up company. Optionally one or more founders may join the social network only once the game has been opened. In stage 4 the group of founders performs the above described activities of the game, while their performance is monitored as previously described. In stage 5, once the game has finished, optionally and preferably the overall performance of the group of founders is evaluated, whether according to an absolute standard or to the relative performance of one or more other groups.

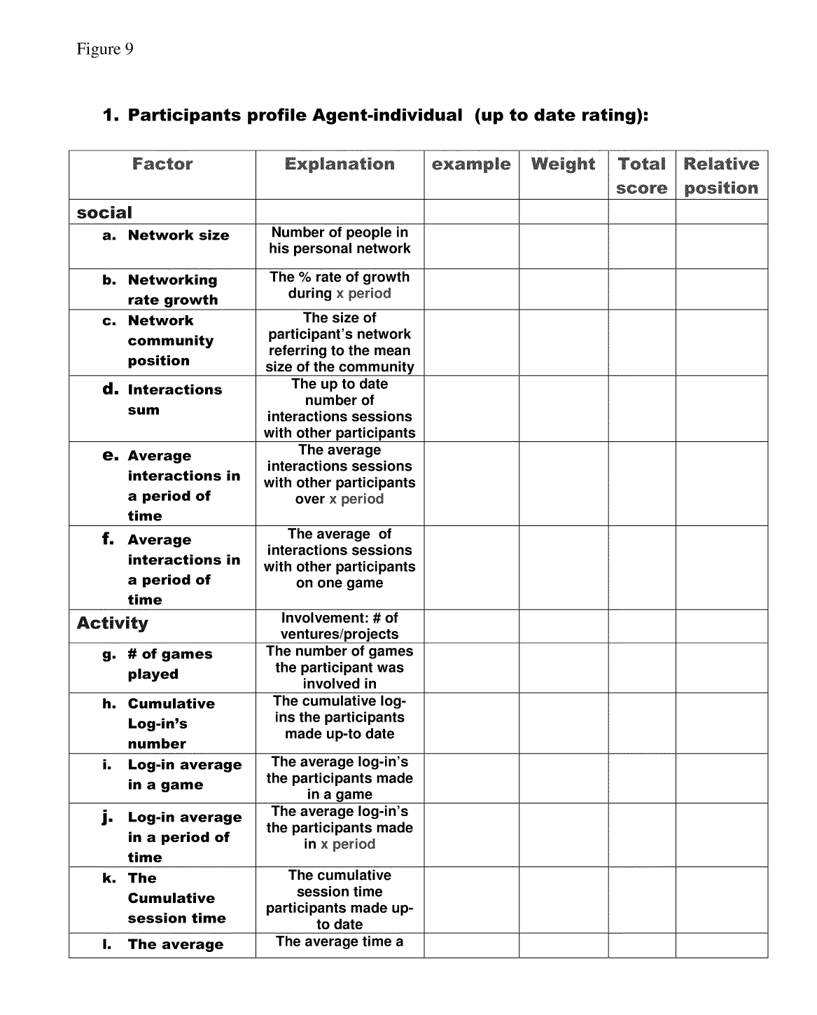

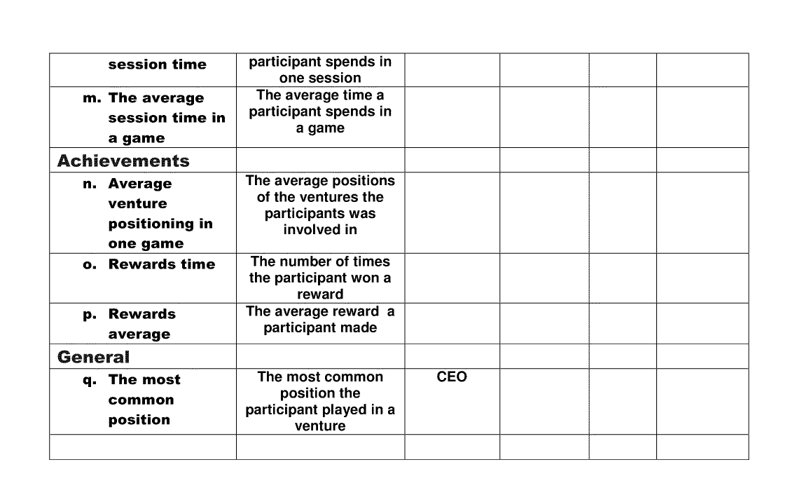

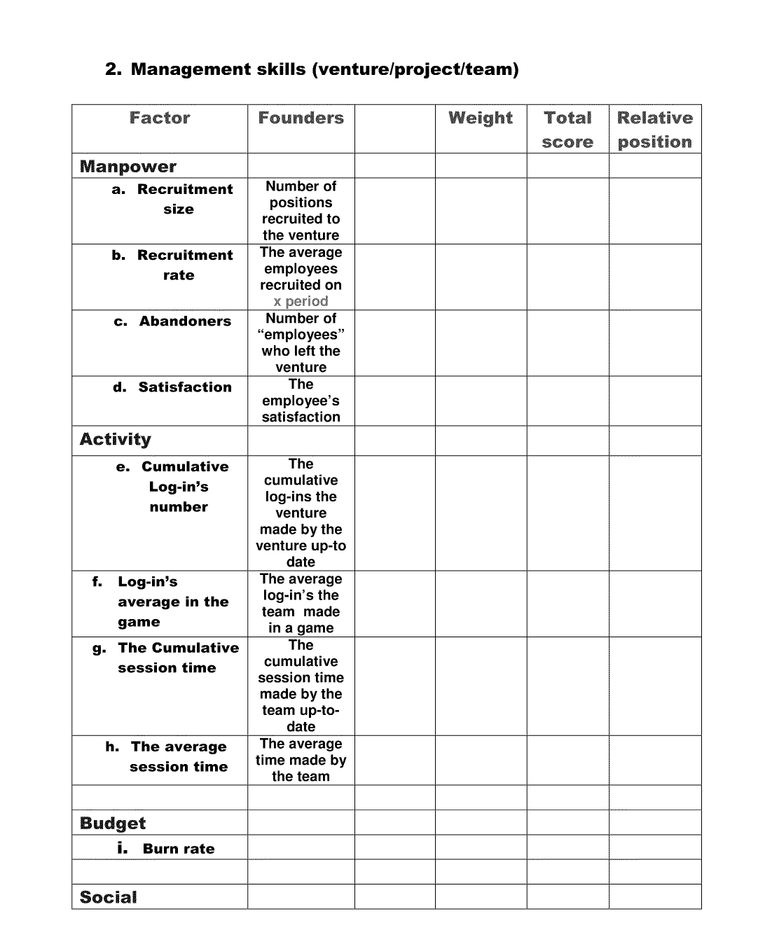

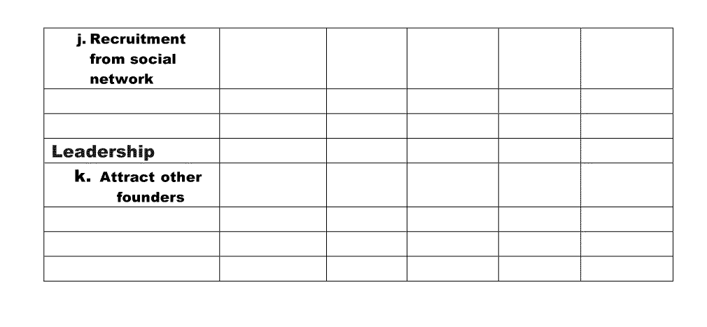

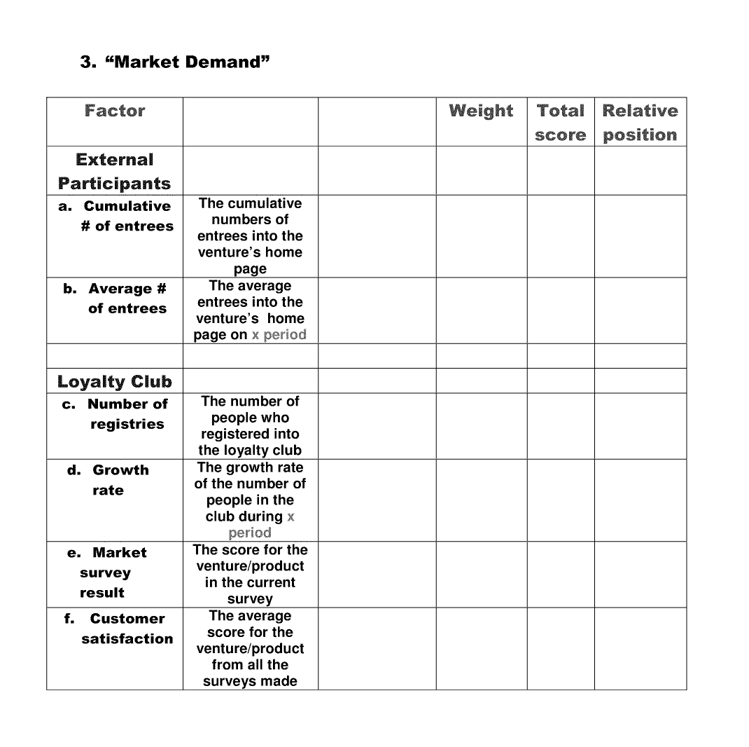

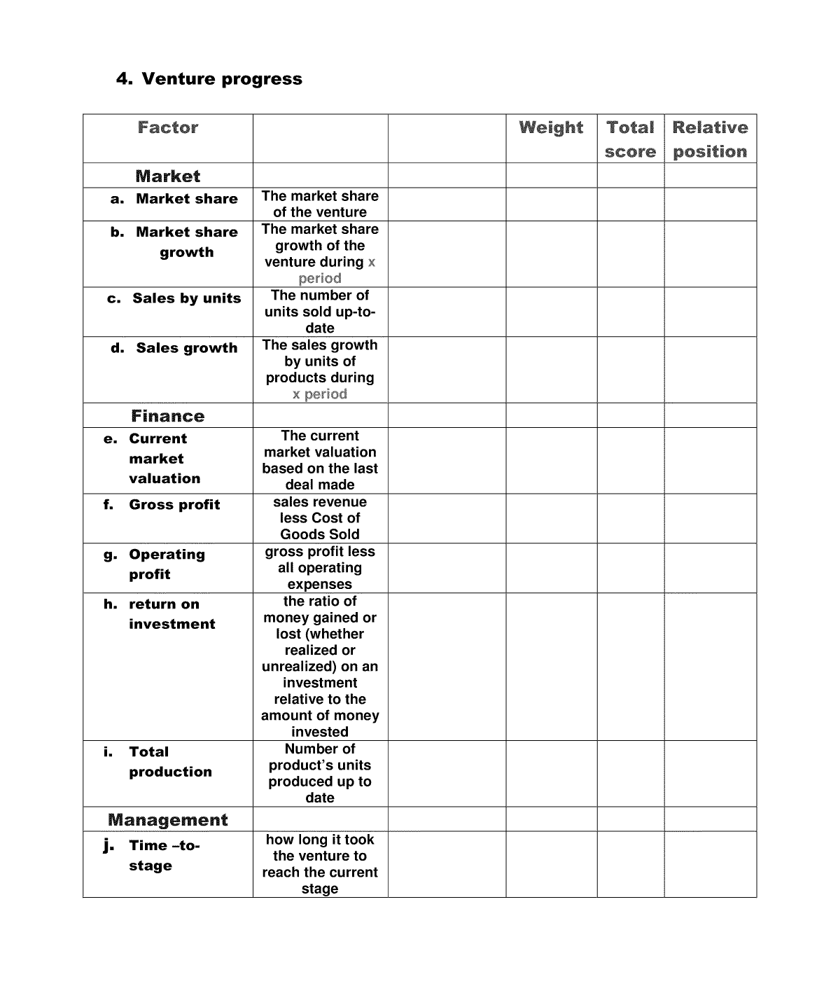

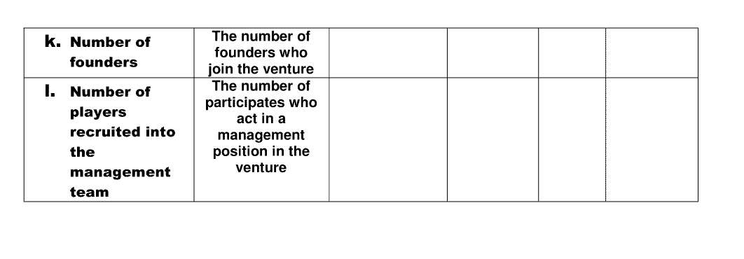

FIGS. 9-1 to 9-4 relate to exemplary, non-limiting illustrative parameter tables relating to one or more parameters for the participant profile agent (FIG. 9-1); the management skills agent (FIG. 9-2); the market demand agent (FIG. 9-3); and the venture progress/status agent (FIG. 9-4). All of these agents were also described with regard to FIG. 2 above. Overall, for a weight value, the default is presented but this value could be set by the administrator through these screen GUIs (graphical user interfaces). Also for relative position, this value determines the relative score of the parameter referring to the overall scores in the game.

These tables specifically relate to the exemplary, non-limiting embodiment in which the game is implemented through a social network, also as described with regard to FIGS. 7 and 8. For example, the first three parameters in FIG. 9-1 relate to the social network aspects of the participant (game player), including social network size and so forth. Other parameters relate to interactions with other players; activities performed during the game; achievements; positions performed during the game and so forth.

FIG. 9-2 relates to such parameters for the management skills of the team of entrepreneurs playing the game together, assuming that in fact the game is played as a team.

FIG. 9-3 relates to parameters for market demand, which as previously described, in the context of a social network relates to the reaction of other participants in the social network to the marketing efforts of the game players.

FIG. 9-4 relates to parameters for the progress of the “company” (team of entrepreneurs or single entrepreneur).

While the invention has been described with respect to a limited number of embodiments, it will be appreciated that many variations, modifications and other applications of the invention may be made.

What is claimed is:

1. A method for performing interactive entrepreneurial activities by a plurality of game players in a virtual environment through a social networking system implemented through a computer network, wherein the method comprises providing a game for being played through said social networking system, said game having an objective; performing a plurality of actions for said game by the plurality of game players with a game interface operated by a user computer, through said social networking system toward said objective; and dynamically reacting to at least one action of each of the plurality of game players by a game engine of said game.

2. The method of claim 1, wherein the computer network comprises the Internet.

3. The method of claim 2, wherein said providing said game further comprises designing the game through customization of at least one parameter.

4. The method of claim 3, wherein said designing the game is performed through a game manager interface performed by a game manager computer, said designing said game further comprising determining said objective of said game, wherein said objective comprises one or more of reaching a predetermined stage of a life cycle of a company, developing a product, promoting or improving an existing product, developing a slogan or developing a marketing campaign.

5. The method of claim 4, wherein said designing the game is controlled by a commercial entity.

6. The method of claim 5, wherein said providing the game further comprises providing a plurality of invitations to the plurality of game players through said social network, such that the plurality of game players is a closed group.

7. The method of claim 4, further comprising evaluating a performance of said actions of said plurality of game players by said game engine.

8. The method of claim 7, wherein said dynamically reacting further comprises determining a profile of said game player; and reacting to said at least one action also according to said profile.

9. The method of claim 7, wherein said evaluating said performance further comprises analyzing one or more characteristics of a social network of a game player within said social networking system.

10. The method of claim 4, wherein said designing the game further comprises providing a language for constructing the game, wherein said language comprises a plurality of objects interacting with each other and wherein said objects perform through said game engine to determine one or more reactions to an action of a game player.

11. The method of claim 10, wherein said designing said game further comprises designing a game client for interacting with said game players through said game interface.

12. The method of claim 10, wherein said language comprises a plurality of keywords, each keyword being related to rule in a rule base for interpretation by said game engine.

13. The method of 1, wherein said providing said game further comprises providing at least one virtual employee or investor; and wherein said plurality of actions includes an interaction between at least one game player and at least one virtual employee or investor.

14. The method of claim 13, wherein said object of the game relates to a specific product and wherein a plurality of game players are competitors for development of said specific product.

15. The method of claim 1, wherein said object of said game relates to a start-up company, the method further comprising providing feedback relating to an action of a game player or to a reaction of a participant in said social networking system.

16. The method of claim 15, further comprising providing a social network profile of a participant in said social networking system specifically for said game.

17. A method for performing interactive entrepreneurial activities of a team of a plurality of game players in a game played through a computer network, the method comprising providing a game interface for being operated by a user computer for interactions of said game players through said computer network; starting a virtual start-up company through the computer network by the team through said game interface; determining a virtual product for said virtual start-up company through the computer network by the team through said game interface; completing a life cycle of the virtual start-up company through one or more actions of the team through said game interface through the computer network; and evaluating a performance of the team over the entire life cycle of said virtual start-up company by a game engine of the game.

18. The method of claim 17 wherein said completing said life cycle comprises performing a plurality of actions by the team through said game interface to reach a plurality of different milestones, wherein at least one milestone includes developing said virtual product.

19. The method of claim 18, wherein at least one other milestone includes one or more of raising funds from at least one investor, recruiting at least one employee and determining a marketing plan for said virtual product.

20. The method of claim 19, wherein said completing said life cycle further comprises dynamically reacting to at least one action of each game player by said game engine.

21. The method of claim 20, wherein the computer network comprises a social networking system operated through the Internet.

22. A system for performing interactive entrepreneurial activities by a plurality of game players through a game played in a virtual environment, comprising: a social networking system implemented through a computer network; a game engine for supporting said game, said game engine interfacing with said social networking system through said computer network; a game interface for being operated by a user computer for interacting with a game player; wherein said game engine dynamically reacts to at least one action of each of the plurality of game players performed through said game interface.
